(19) United States
(12) Patent Application Publication
(10) Pub. No.: US 2009/0038003 A1
(43) Pub. Date: Feb. 5, 2009

(54) SYSTEM AND PROCESS FOR SECURITY CONTROL OF A PROJECTOR

(75) Inventor: WEN-CHIN HSIEH, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/038,993

(22) Filed: Feb. 28, 2008

(30) Foreign Application Priority Data
Jul. 30, 2007 (CN) 200710201216.4

(51) Int. Cl. H04L 9/32; H04L 9/06

(52) U.S. Cl. 726/19; 380/277

(57) ABSTRACT

An exemplary projector crypto system includes a key storage unit, a password inputting unit, a comparing unit, and a switch module. The key unit is configured for determining and storing a secret picture for operating the projector. The password inputting unit is configured for reading a picture input by a user. The comparing unit is configured for determining whether the input picture is identical to the secret picture. The switch module activates the projector only if the input picture is identical to the secret picture.

### TECHNICAL FIELD

The present invention relates to a crypto system and process thereof, and specifically, to a system and process for controlling use of a projector.

### BACKGROUND

Projectors used in academic or business places are often accessible by many users and so some method to restrict use by non-authorized persons is employed. The most common way to ensure authorized use of the projector is requiring inputting of a password to unlock a security control that allows use of the projector. The password typically comprises numbers or letters or a combination thereof. However, the passwords are easily cracked, and the method requires the added expense of an input device such as a keyboard.

Therefore, it is desired to provide a simple, easy way to prevent unauthorized use of a projector.

### SUMMARY

In accordance with a present embodiment, a projector crypto system is provided. The projector crypto system includes a key storage unit, a password inputting unit, a comparing unit, and a switch module. The key storage unit is configured for determining and storing a secret picture as a key for operating the projector. The password inputting unit is configured for reading a picture input by a user. The comparing unit is configured for determining whether the input picture is identical to the secret picture. The switch module is configured for activating the projector only if the input picture is identical to the secret picture.

Other novel features and advantages will be drawn from the following detailed description of at least one preferred embodiment, when considered in conjunction with the attached drawings.

### BRIEF DESCRIPTION OF THE DRAWINGS

Many aspects of the present projector crypto system and process can be better understood with reference to the following drawings. The components in the drawings are not necessarily drawn to scale, the emphasis instead being placed upon clearly illustrating the principles of the present projector crypto system and process. Moreover, in the drawings, like reference numerals designate corresponding parts throughout the several views.

FIG. 1 is a function block diagram of a projector crypto system in a present embodiment of this invention.

FIG. 2 is a flow chart of a process for switching on according to the present embodiment of this invention.

### DETAILED DESCRIPTION OF THE PREFERRED EMBODIMENTS

Embodiments of the present projector crypto system and process will now be described in detail below and with reference to the drawings.

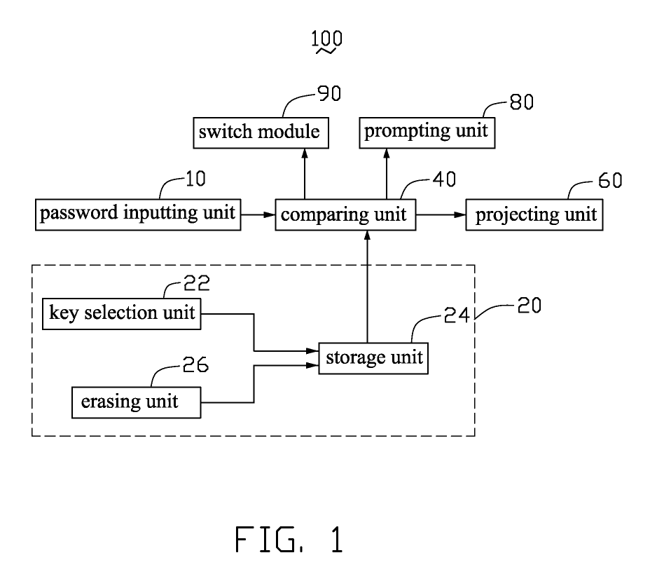

Referring to FIG. 1, a function block diagram of a projector crypto system 100 in accordance with a present embodiment is shown. The projector crypto system 100 is configured for controlling use of a projector. The projector crypto system 100 includes a password inputting unit 10, a key storage unit 20, a comparing unit 40, and a projecting unit 60, and a prompting unit 80, and a switch module 90. The comparing unit 40 is electrically connected with the password inputting unit 10, the key storage unit 20, the projecting unit 60, and the prompting unit 80, and the switch module 90.

The password inputting unit 10 is configured for reading a picture input by a user. The key storage unit 20 includes a key selection unit 22, a storage unit 24, and an erasing unit 26. The key selection unit 22 and the erasing unit 26 are electrically connected with the storage unit 24. The key selection unit 22 is configured for determining a secret picture as a key for operating the projector. The secret picture is stored in the storage unit 24. The erasing unit 26 is configured for erasing the secret picture stored in the storage unit 24 in order to set a new secret picture as the key for operating the projector.

The comparing unit 40 electrically connects with the password inputting unit 10 and the storage unit 24. The comparing unit 40 is configured for determining whether the input picture obtained from the password inputting unit 10 is identical to the secret picture stored in the storage unit 24. If the input picture is identical to the secret picture, the projecting unit 60 is activated by the switch module 90 for use. If the input picture is not identical to the secret picture, the prompting unit 80 indicates an error and the projector is not activated for use.

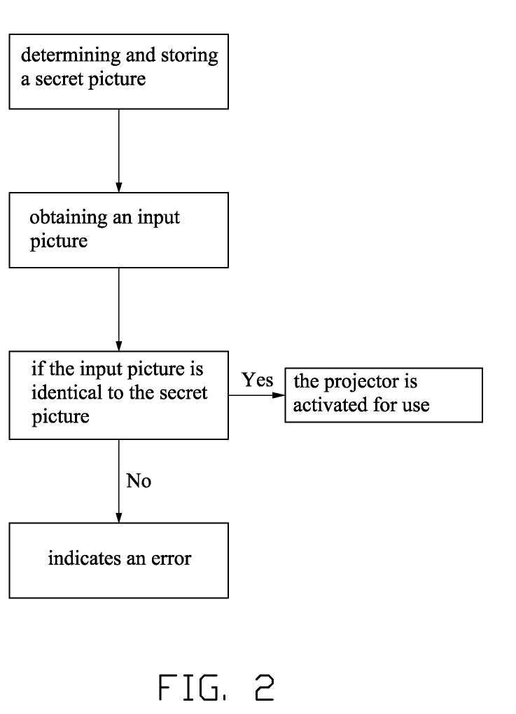

Referring to FIG. 2, a flow chart of a process for switching on a projector in accordance with the present embodiment is shown. The process includes:

determining and storing a secret picture;

obtaining a picture input by a user;

comparing the input picture with the secret picture; and

activating the projector only if the input picture is identical to the secret picture.

In this process, the secret picture is determined by the key selection unit 22 of the key storage unit 20 and stored in the storage unit 24 as a key for controlling use of the projector. The key selection unit 22 can be, for example, a computer, a handset, or a projector having an image capture function to determine the secret picture. The secret picture can be a bit-map (BMP), tagged image file format (TIFF) or other available format for still pictures.

The input picture in the process is obtained from the password inputting unit 10. The password inputting unit 10 can be, for example, a computer, a handset, or a projector having an image capture function to receive the input picture. The input picture is compared with the secret picture by the comparing unit 40 to determine whether the input picture is identical to the secret picture. If the input picture obtained from the password inputting unit 10 is identical to the secret picture stored in the storage unit 24, the projector is activated for further operations. If the input picture is not identical to the secret picture, the prompting unit 80 indicates an error and the projector does not activate for further operations.

The secret picture of the projector can be changed if the secret picture is correctly input. The erasing unit 26 can erase the secret picture stored in the storage unit 24. A new secret picture can be determined by the key selection unit 22 and stored by the storage unit 24 for controlling use of the protector.

It will be understood that the above particular embodiments are described and shown in the drawings by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A projector cryptosystem comprising:
a key storage unit configured for determining and storing a secret picture;
a password inputting unit configured for reading a picture input by a user;
a comparing unit configured for determining whether the input picture is identical to the secret picture; and
a switch module for activating the projector only if the input picture is identical to the secret picture.

2. The projector crypto system as claimed in claim 1, wherein the key storage unit comprises a key selection unit configured for selecting and determining a picture as the secret picture.

3. The projector crypto system as claimed in claim 1, wherein the key storage unit comprises a storage unit configured for storing the secret picture.

4. The projector crypto system as claimed in claim 1, wherein the key storage unit comprises an erasing unit configured for erasing the secret picture.

5. The projector crypto system as claimed in claim 1, further comprising a prompting unit configured for indicating an error if the input picture is not identical to the secret picture.

6. A process for switching on a projector comprising:
determining and storing a secret picture;
obtaining a picture input by a user;
comparing the input picture with the secret picture; and
activating the projector only if the input picture is identical to the secret picture.

7. The process as claimed in claim 6, further comprising:
indicating an error if the input picture is not identical to the secret picture.
